(19) United States
(12) Patent Application Publication
(10) Pub. No.: US 2022/0263416 A1
(43) Pub. Date: Aug. 18, 2022

(54) A RESONANT CIRCUIT CONVERTER AND CONTROL METHOD

(71) Applicant: shunzhu TAO, tangshan (CN)

(72) Inventor: shunzhu TAO, tangshan (CN)

(21) Appl. No.: 17/626,286

(22) PCT Filed: Jan. 5, 2021
(86) PCT No.: PCT/CN2021/070374

§ 371 Date: Jan. 11, 2022

(30) Foreign Application Priority Data
Mar. 6, 2020 (CN) 202010154926.1

(51) Int. Cl. H02M 3/335; H02M 3/00; H02M 1/00; H02M 3/337

(52) U.S. Cl. CPC H02M 3/33571; H02M 3/337; H02M 1/0009; H02M 3/01

(57) ABSTRACT

This invention discloses a resonant circuit converter and control method, including a resonant circuit, a main loop energy detection circuit and a dual port PWM control circuit. The main loop energy detection circuit includes a main loop current sensing rectification circuit, a current comparator and a current slop compensation circuit. Dual port PWM control circuit includes: voltage comparator, OSC oscillator and PWM phase split control. The invention adopts PWM control mode to control the output voltage Vo under the condition that the resonant circuit electronic switch ZVS is. The on-time control characteristic, line regulation rate and load regulation rate of the main loop current of the resonant circuit are equivalent to the output characteristic of the current mode PWM control circuit in the state of the hard switching circuit.

### TECHNICAL FIELD

This present invention belongs to nonlinear control technology, which specifically relates to a resonant circuit converter its control method.

### BACKGROUND ART

The existing resonant circuits include series resonant circuit, parallel resonant circuit, series parallel resonant circuit, LLC resonant circuit, etc.

In the resonant circuit, when controlling switch to adjust the adjust the output voltage, the output voltage of resonance circuit can be adjusted through PFM (Pulse Frequency Modulation, PFM), also can be through the PWM (Pulse Width Modulation, PWM) to adjust the output voltage of resonance circuit, also the combination of two kinds of Modulation methods, namely the PWM and PFM to adjust the output voltage of resonance circuit.

### SUMMARY OF INVENTION

### Technical Problem

In order to improve the output characteristics of resonant converter circuit, PFM+PWM control mode is adopted in some patents such as CN201010134302.X, CN201010213382, CN101969303B, CN1885699A, CN109194111A. Although this mode solves the voltage regulation problem of PWM mode of LLC converter in the state of low energy transformation, the resonant circuit loses the condition of ZVS in the state of PWM.

### Solution to Problem

### Technical Solution

In order to solve the above technical problems, this invention presents a resonant circuit converter and its control method.

To achieve the above purpose, the technical scheme of the invention is as follows:

A resonant circuit converter includes: a resonant circuit. Main loop energy detection circuit, including: the main loop current sensing rectification, current comparator and current slop compensation circuit, the main loop current sampling of the rectification input by pulse resonance circuit described the main loop current Ip, the main loop current collection and output of the rectification respectively and described in the current input of slop compensation circuit and current comparator one input end of the electrical connections, and described the current comparator another input connected to the reference voltage Vf electricity;

Dual port PWM control circuit, including: Voltage comparator, OSC oscillator and PWM phase split control, voltage comparator described one of the input and the output of the slop compensation circuit is described in the current electric connection, described the another input terminal of the voltage comparator and the output voltage of resonance circuit described Vo electrical connection, described the reset end of the OSC oscillator is described and the output end of the current comparator electric connection, as described in the output of the voltage comparator and the output of the oscillator OSC respectively and PWM phase split control of two input electrical connection, described in the PWM phase split control output drive pulse ton1 and drive pulse ton2, the driving pulse ton1 is used to drive the electronic switch S1 in the resonant circuit, and the driving pulse ton2 is used to drive the electronic switch S2 in the resonant circuit.

Dual port PWM control circuit, including: Voltage comparator, OSC oscillator and PWM phase split control, voltage comparator described one of the input and the output of the slop compensation circuit is described in the current electric connection, described the another input terminal of the voltage comparator and the output voltage of resonance circuit described Vo electrical connection, described the reset end of the OSC oscillator is described and the output end of the current comparator electric connection, as described in the output of the voltage comparator and the output of the oscillator OSC respectively and PWM phase split control of two input electrical connection, described in the PWM phase split control output drive pulse ton1 and drive pulse ton2, the driving pulse ton1 is used to drive the electronic switch S1 in the resonant circuit, and the driving pulse ton2 is used to drive the electronic switch S2 in the resonant circuit.

Based on the above technical proposal, the following improvements can be made:

As a preferred scheme, the lowest oscillation frequency fm of the OSC oscillator is less than the center frequency fo of the resonant circuit of the main loop.

As the preferred scheme, the resonant circuit is one or more of series resonant circuit, parallel resonant circuit, series parallel resonant circuit and LLC resonant circuit

As a preferred scheme, the topology of the resonant circuit can be one or more of the full-bridge structure, half-bridge structure, push-pull structure.

This invention also discloses a resonant circuit converter control method, which uses the resonant circuit converter to control the output characteristics of the resonant circuit, and regulates the output voltage Vo of the resonant circuit by changing the driving pulse ton1 width of the resonant circuit electronic switch S1 and the driving pulse ton2 width of the electronic switch S2.

As the preferred scheme, the drive pulse ton1 and drive pulse ton2 output by PWM phase split control, and its opening pulse is controlled by the output pulse Ip23 of the current comparator.

As the preferred scheme, the main loop current sampling of the rectification input by pulse resonance circuit of main loop current Ip, Ip21 rectification output voltage signal to current comparator of one of the input, and described the current comparator reference voltage at the input to another Vf compared;

When Ip2 is less than Vf, the output end of the current comparator outputs the pulse Ip23 to the reset end of the OSC oscillator, and the OSC oscillator is reset. After the output end of the OSC oscillator passes the dead zone time td, the output pulse Ip32 to an input end of the PWM phase split control;

The PWM phase split control takes the pulse Ip32 as the on pulse output of the driving pulse ton1 and driving pulse ton2 in the lower half period, and the corresponding electronic switch ZVS in the lower half period of the resonant circuit is opened.

As the preferred scheme, the dead zone time td of the OSC oscillator is less than the waveform TZVS time at the output end of the main ring current acquisition rectifier.

As the preferred scheme, the drive pulse ton1 and drive pulse ton2 output by the PWM phase split control are controlled by the ratio of the output pulse Ip22 and output Vo of the current ramp compensation circuit.

As optimization scheme, when the output pulse Ip22 of current slope compensation circuit is greater than the Vo, the output of the voltage comparator output pulse Vp31 to another input terminal of PWM phase split control, PWM pulse Vp31 as split phase control is the opening of the half cycle drive pulse ton1 and driven by the pulse output, pulse ton2 resonant circuit is the opening of the half cycle of the electronic switch close;

The resonant circuit completes PWM regulation of the output voltage Vo.

### Advantageous Effects of Invention

### Advantageous Effects

This invention discloses a kind of resonant circuit converter and control method. The driving pulse ton1 of the electronic switch S1 and the driving pulse ton2 of the electronic switch S2 are regulated by PWM. Under the condition that the resonant circuit electronic switch ZVS is open, the output voltage V0 is regulated by PWM control. The transient control characteristic, voltage adjustment rate and load adjustment rate of the main loop current of the resonant circuit are equivalent to the output characteristic of the current-type PWM control circuit in the state of the hard switching circuit.

### BRIEF DESCRIPTION OF DRAWINGS

### Description of Drawings

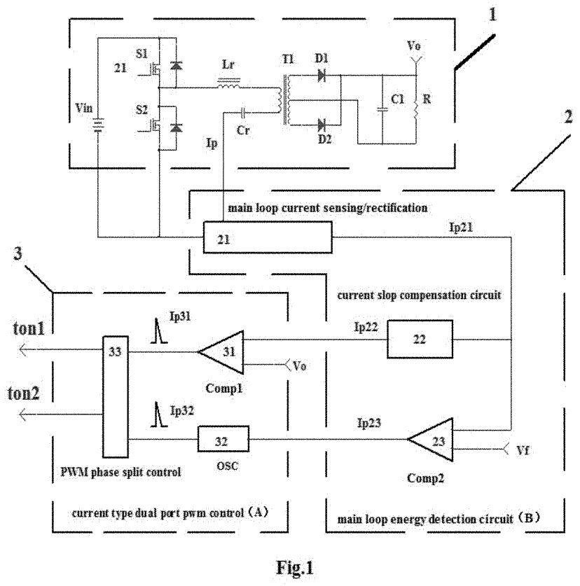

FIG. 1 is a circuit block diagram of a resonant circuit converter provided by an embodiment of the present invention.

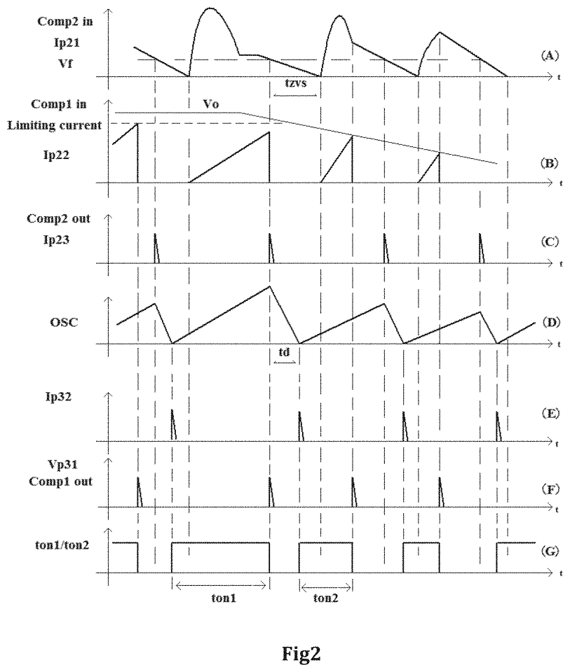

FIG. 2 is the schematic diagram of each pulse provided by the embodiment of the invention;

FIG. 2 (A) is the pulse sequence diagram of pulse Ip21.

FIG. 2 (B) is the pulse sequence diagram of pulse Ip22.

FIG. 2 (C) is the pulse sequence diagram of pulse Ip23.

FIG. 2 (D) is the pulse sequence diagram of OSC oscillator.

FIG. 2 (E) is the pulse sequence diagram of pulse Ip32.

FIG. 2 (F) is the pulse sequence diagram of pulse Vp31.

FIG. 2 (G) is the pulse sequence diagram of driving pulse ton1 or driving pulse ton2.

wherein: 1—resonant circuit, 2—main loop energy detection circuit, 21—main loop current sensing rectification circuit, 22—current slop compensation circuit, 23—current comparator, 3—dual port PWM control, 31—voltage comparator, 32—osc oscillator, 33—PWM phase split control

### BEST MODE FOR CARRYING OUT THE INVENTION

### Best Mode

The following figures illustrates the preferred embodiment of the invention together with the attached drawings in detail.

For the purpose of the invention, a resonant circuit converter and some embodiments of the control method, as shown in FIG. 1, include:

Resonant circuit 1;

Main loop energy detection circuit 2, including: main loop current sensing rectification circuit 21, current comparator 23 (Comp2) and current slop compensation circuit 22, the input end of the main loop current sensing rectification circuit 21 senses main loop current Ip cycle by cycle, the output of main loop current sensing rectification circuit 21 respectively with current input of slop compensation circuit 22 and one input end of the current comparator 23 electric connection, and the current comparator 23 of the other input end connected to the reference voltage Vf electricity;

Dual terminal PWM control circuit 3, including: Voltage comparator (Comp1) 31, OSC oscillator 32 and PWM phase split control 33, one input terminal of the voltage comparator 31 and slope compensation circuit and the output end of the current electric connect, the other side of the voltage comparator 31 input and the output voltage of resonance circuit 1 Vo electrical connection, the OSC oscillator 32 reset the client and the current electrical connection, the output of the comparator and the output of the voltage comparator 31 and the output of OSC oscillator 32 and PWM controller are connected respectively to the two input end of PWM phase split control 33, PWM phase split control 33 outputs drive pulse ton1 and drive pulse ton2, drive pulse ton1 is used to drive the electronic switch S1 in resonant circuit 1, drive pulse ton2 is used to drive the electronic switch S2 in resonant circuit 1.

In order to further optimize the implementation effect of this invention, in other embodiments, the remaining characteristic of the technologies are the same, except that the lowest oscillation frequency fm of OSC oscillator 32 is less than the center frequency fo of the main loop of the resonant circuit.

In order to further optimize the implementation effect of the invention, other characteristic of the technologies are the same in other embodiments, except that resonant circuit 1 is one or more of series resonant circuit, parallel resonant circuit, series parallel resonant circuit and LLC resonant circuit.

In order to further optimize the implementation effect of the invention, in other embodiments, the remaining characteristic of the technologies are the same, except that the topology structure of resonant circuit 1 can be one or more of the full-bridge structure, half-bridge structure, push-pull structure.

This invention also discloses a resonant circuit converter control method, which uses a resonant circuit converter to control the output characteristics of resonant circuit 1, and regulates the output voltage Vo of resonant circuit 1 by changing the driving pulse ton1 width of the resonant circuit electronic switch S1 and the driving pulse ton2 width of the electronic switch S2.

In order to further optimize the implementation effect of the invention, other characteristic of the technologies are the same in other embodiment, except that the drive pulse ton1 and drive pulse ton2 output by PWM phase split control 33 are controlled by the output pulse Ip23 of current comparator 23 (as shown in FIG. 2 (C)).

Further, the input end of the main loop current sensing rectification 21 collects the resonant circuit current Ip by pulse, and the rectification output voltage signal Ip21 (as shown in FIG. 2 (A)) goes to one of the input ends of the current comparator 23, and is compared with the reference voltage Vf of the other input end of the current comparator 23.

When Ip21 less than Vf, the output end of current comparator 23 output pulse Ip23 (as shown in FIG. 2 (C)) to OSC oscillator 32 reset end (as shown in FIG. 2 (D)), the OSC oscillator 32 reset, the output of the oscillator OSC 32 output pulse Ip32 (as shown in FIG. 2 (E)) to an input terminal of PWM phase split control 33 after passing dead band time td;

PWM phase split control 33 outputs pulse Ip32 as the opening pulse of drive pulse ton1 and drive pulse ton2 in the second half cycle (as shown in FIG. 2 (G)), and the corresponding electronic switch ZVS in the second half cycle of the resonant circuit is opened.

Furthermore, the dead zone time td of OSC oscillator 32 is less than the waveform TZVS time at the output end of the main loop current sensing rectification 21.

Furthermore, the output drive pulse ton1 and drive pulse ton2 of PWM phase split control 33 are controlled by the ratio of output pulse Ip22 and output Vo of current ramp compensation circuit 22 (as shown in FIG. 2 (B)).

Further, when the output pulse Ip22 of current slop compensation circuit 22 (as shown in FIG. 2 (B)) is greater than the Vo, voltage comparator and the output end of the output pulse Vp31 (as shown in FIG. 2 (F)) to the another input of PWM phase split control 33, PWM phase split control 33 will pulse Vp31 (as shown in FIG. 2 (F)) as the opening of the half cycle is driven pulse ton2 ton1 and drive pulse by pulse output (as shown in FIG. 2 (G)), the opening of the half cycle of the resonant circuit is electronic switch close;

The resonant circuit completes PWM regulation of output voltage Vo.

The above multiple implementations can be implemented in cross or parallel implement . . . .

### MODE FOR THE INVENTION

### Mode for Invention

The invention discloses a resonant circuit converter and control method. The driving pulse ton1 of the electronic switch S1 and the driving pulse ton2 of the electronic switch S2 are regulated by PWM. The transient control characteristic, voltage adjustment rate and load adjustment rate of the main loop current of the resonant circuit are equivalent to the output characteristic of the current-type PWM control circuit in the state of the hard switching circuit.

### INDUSTRIAL APPLICABILITY

It avoids the problem that the resonant circuit conversion n efficiency is reduced and the main loop current is out of control under no loading or light load condition when the resonant circuit adopts PFM+PWM two control methods.

As for the preferred embodiment of the invention, it should be pointed out that for ordinary technicians in the field, a number of modifications and improvements can be made on the premise of not deviating from the concept of the invention creation, which are within the scope of protection of the invention.

### SEQUENCE LISTING FREE TEXT

### Sequence List Text

Input the paragraph which describes the sequence list text here.

### TECHNICAL FIELD

This present invention belongs to nonlinear control technology, which specifically relates to a resonant circuit converter its control method.

### BACKGROUND ART

The existing resonant circuits include series resonant circuit, parallel resonant circuit, series parallel resonant circuit, LLC resonant circuit, etc.

In the resonant circuit, when controlling switch to adjust the adjust the output voltage, the output voltage of resonance circuit can be adjusted through PFM (Pulse Frequency Modulation, PFM), also can be through the PWM (Pulse Width Modulation, PWM) to adjust the output voltage of resonance circuit, also the combination of two kinds of Modulation methods, namely the PWM and PFM to adjust the output voltage of resonance circuit.

### Technical Problem

In order to improve the output characteristics of resonant converter circuit, PFM+PWM control mode is adopted in some patents such as CN201010134302.X, CN201010213382, CN101969303B, CN1885699A, CN109194111A. Although this mode solves the voltage regulation problem of PWM mode of LLC converter in the state of low energy transformation, the resonant circuit loses the condition of ZVS in the state of PWM.

### Technical Solution

In order to solve the above technical problems, this invention presents a resonant circuit converter and its control method.

To achieve the above purpose, the technical scheme of the invention is as follows:

A resonant circuit converter includes: a resonant circuit, Main loop energy detection circuit, including: the main loop current sensing rectification, current comparator and current slop compensation circuit, the main loop current sampling of the rectification input by pulse resonance circuit described the main loop current Ip, the main loop current collection and output of the rectification respectively and described in the current input of slop compensation circuit and current comparator one input end of the electrical connections, and described the current comparator another input connected to the reference voltage Vf electricity;

Dual port PWM control circuit, including: Voltage comparator, OSC oscillator and PWM phase split control, voltage comparator described one of the input and the output of the slop compensation circuit is described in the current electric connection, described the another input terminal of the voltage comparator and the output voltage of resonance circuit described Vo electrical connection, described the reset end of the OSC oscillator is described and the output end of the current comparator electric connection, as described in the output of the voltage comparator and the output of the oscillator OSC respectively and PWM phase split control of two input electrical connection, described in the PWM phase split control output drive pulse ton1 and drive pulse ton2, the driving pulse ton1 is used to drive the electronic switch S1 in the resonant circuit, and the driving pulse ton2 is used to drive the electronic switch S2 in the resonant circuit.

Dual port PWM control circuit, including: Voltage comparator, OSC oscillator and PWM phase split control, voltage comparator described one of the input and the output of the slop compensation circuit is described in the current electric connection, described the another input terminal of the voltage comparator and the output voltage of resonance circuit described Vo electrical connection, described the reset end of the OSC oscillator is described and the output end of the current comparator electric connection, as described in the output of the voltage comparator and the output of the oscillator OSC respectively and PWM phase split control of two input electrical connection, described in the PWM phase split control output drive pulse ton1 and drive pulse ton2, the driving pulse ton1 is used to drive the electronic switch S1 in the resonant circuit, and the driving pulse ton2 is used to drive the electronic switch S2 in the resonant circuit.

Based on the above technical proposal, the following improvements can be made:

As a preferred scheme, the lowest oscillation frequency fin of the OSC oscillator is less than the center frequency fo of the resonant circuit of the main loop.

As the preferred scheme, the resonant circuit is one or more of series resonant circuit, parallel resonant circuit, series parallel resonant circuit and LLC resonant circuit

As a preferred scheme, the topology of the resonant circuit can be one or more of the full-bridge structure, half-bridge structure, push-pull structure.

This invention also discloses a resonant circuit converter control method, which uses the resonant circuit converter to control the output characteristics of the resonant circuit, and regulates the output voltage Vo of the resonant circuit by changing the driving pulse ton1 width of the resonant circuit electronic switch S1 and the driving pulse ton2 width of the electronic switch S2.

As the preferred scheme, the drive pulse ton1 and drive pulse ton2 output by PWM phase split control, and its opening pulse is controlled by the output pulse Ip23 of the current comparator.

As the preferred scheme, the main loop current sampling of the rectification input by pulse resonance circuit of main loop current Ip, Ip21 rectification output voltage signal to current comparator of one of the input, and described the current comparator reference voltage at the input to another Vf compared;

When Ip2 is less than Vf, the output end of the current comparator outputs the pulse Ip23 to the reset end of the OSC oscillator, and the OSC oscillator is reset. After the output end of the OSC oscillator passes the dead zone time td, the output pulse Ip32 to an input end of the PWM phase split control;

The PWM phase split control takes the pulse Ip32 as the on pulse output of the driving pulse ton1 and driving pulse ton2 in the lower half period, and the corresponding electronic switch ZVS in the lower half period of the resonant circuit is opened.

As the preferred scheme, the dead zone time td of the OSC oscillator is less than the waveform TZVS time at the output end of the main ring current acquisition rectifier.

As the preferred scheme, the drive pulse ton1 and drive pulse ton2 output by the PWM phase split control are controlled by the ratio of the output pulse Ip22 and output Vo of the current ramp compensation circuit.

As optimization scheme, when the output pulse Ip22 of current slope compensation circuit is greater than the Vo, the output of the voltage comparator output pulse Vp31 to another input terminal of PWM phase split control, PWM pulse Vp31 as split phase control is the opening of the half cycle drive pulse ton1 and driven by the pulse output, pulse ton2 resonant circuit is the opening of the half cycle of the electronic switch close;

The resonant circuit completes PWM regulation of the output voltage Vo.

### Advantageous Effects

This invention discloses a kind of resonant circuit converter and control method. The driving pulse ton1 of the electronic switch S1 and the driving pulse ton2 of the electronic switch S2 are regulated by PWM. Under the condition that the resonant circuit electronic switch ZVS is open, the output voltage V0 is regulated by PWM control. The transient control characteristic, voltage adjustment rate and load adjustment rate of the main loop current of the resonant circuit are equivalent to the output characteristic of the current-type PWM control circuit in the state of the hard switching circuit . . . .

### DESCRIPTION OF DRAWINGS

FIG. 1 is a circuit block diagram of a resonant circuit converter provided by an embodiment of the present invention.

FIG. 2 is the schematic diagram of each pulse provided by the embodiment of the invention;

FIG. 2 (A) is the pulse sequence diagram of pulse Ip21.

FIG. 2 (B) is the pulse sequence diagram of pulse Ip22.

FIG. 2 (C) is the pulse sequence diagram of pulse Ip23.

FIG. 2 (D) is the pulse sequence diagram of OSC oscillator.

FIG. 2 (E) is the pulse sequence diagram of pulse Ip32.

FIG. 2 (F) is the pulse sequence diagram of pulse Vp31.

FIG. 2 (G) is the pulse sequence diagram of driving pulse ton1 or driving pulse ton2.

wherein: 1—resonant circuit, 2—main loop energy detection circuit, 21—main loop current sensing rectification circuit, 22—current slop compensation circuit, 23—current comparator, 3—dual port PWM control, 31—voltage comparator, 32—osc oscillator, 33—PWM phase split control

### BEST MODE

The following figures illustrates the preferred embodiment of the invention together with the attached drawings in detail.

For the purpose of the invention, a resonant circuit converter and some embodiments of the control method, as shown in FIG. 1, include:

Resonant circuit 1;

Main loop energy detection circuit 2, including: main loop current sensing rectification circuit 21, current comparator 23 (Comp2) and current slop compensation circuit 22, the input end of the main loop current sensing rectification circuit 21 senses main loop current Ip cycle by cycle, the output of main loop current sensing rectification circuit 21 respectively with current input of slop compensation circuit 22 and one input end of the current comparator 23 electric connection, and the current comparator 23 of the other input end connected to the reference voltage Vf electricity;

Dual terminal PWM control circuit 3, including: Voltage comparator (Comp1) 31, OSC oscillator 32 and PWM phase split control 33, one input terminal of the voltage comparator 31 and slope compensation circuit and the output end of the current electric connect, the other side of the voltage comparator 31 input and the output voltage of resonance circuit 1 Vo electrical connection, the OSC oscillator 32 reset the client and the current electrical connection, the output of the comparator and the output of the voltage comparator 31 and the output of OSC oscillator 32 and PWM controller are connected respectively to the two input end of PWM phase split control 33, PWM phase split control 33 outputs drive pulse ton1 and drive pulse ton2, drive pulse ton1 is used to drive the electronic switch S1 in resonant circuit 1, drive pulse ton2 is used to drive the electronic switch S2 in resonant circuit 1.

In order to further optimize the implementation effect of this invention, in other embodiments, the remaining characteristic of the technologies are the same, except that the lowest oscillation frequency fm of OSC oscillator 32 is less than the center frequency fo of the main loop of the resonant circuit.

In order to further optimize the implementation effect of the invention, other characteristic of the technologies are the same in other embodiments, except that resonant circuit 1 is one or more of series resonant circuit, parallel resonant circuit, series parallel resonant circuit and LLC resonant circuit.

In order to further optimize the implementation effect of the invention, in other embodiments, the remaining characteristic of the technologies are the same, except that the topology structure of resonant circuit 1 can be one or more of the full-bridge structure, half-bridge structure, push-pull structure.

This invention also discloses a resonant circuit converter control method, which uses a resonant circuit converter to control the output characteristics of resonant circuit 1, and regulates the output voltage Vo of resonant circuit 1 by changing the driving pulse ton1 width of the resonant circuit electronic switch S1 and the driving pulse ton2 width of the electronic switch S2.

In order to further optimize the implementation effect of the invention, other characteristic of the technologies are the same in other embodiment, except that the drive pulse ton1 and drive pulse ton2 output by PWM phase split control 33 are controlled by the output pulse Ip23 of current comparator 23 (as shown in FIG. 2 (C)).

Further, the input end of the main loop current sensing rectification 21 collects the resonant circuit current Ip by pulse, and the rectification output voltage signal Ip21 (as shown in FIG. 2 (A)) goes to one of the input ends of the current comparator 23, and is compared with the reference voltage Vf of the other input end of the current comparator 23.

When Ip21 less than Vf, the output end of current comparator 23 output pulse Ip23 (as shown in FIG. 2 (C)) to OSC oscillator 32 reset end (as shown in FIG. 2 (D)), the OSC oscillator 32 reset, the output of the oscillator OSC 32 output pulse Ip32 (as shown in FIG. 2 (E)) to an input terminal of PWM phase split control 33 after passing dead band time td;

PWM phase split control 33 outputs pulse Ip32 as the opening pulse of drive pulse ton1 and drive pulse ton2 in the second half cycle (as shown in FIG. 2 (G)), and the corresponding electronic switch ZVS in the second half cycle of the resonant circuit is opened.

Furthermore, the dead zone time td of OSC oscillator 32 is less than the waveform TZVS time at the output end of the main loop current sensing rectification 21.

Furthermore, the output drive pulse ton1 and drive pulse ton2 of PWM phase split control 33 are controlled by the ratio of output pulse Ip22 and output Vo of current ramp compensation circuit 22 (as shown in FIG. 2 (B)).

Further, when the output pulse Ip22 of current slop compensation circuit 22 (as shown in FIG. 2 (B)) is greater than the Vo, voltage comparator and the output end of the output pulse Vp31 (as shown in FIG. 2 (F)) to the another input of PWM phase split control 33, PWM phase split control 33 will pulse Vp31 (as shown in FIG. 2 (F)) as the opening of the half cycle is driven pulse ton2 ton1 and drive pulse by pulse output (as shown in FIG. 2 (G)), the opening of the half cycle of the resonant circuit is electronic switch close;

The resonant circuit completes PWM regulation of output voltage Vo.

The above multiple implementations can be implemented in cross or parallel implement . . . .

### Mode for Invention

The invention discloses a resonant circuit converter and control method. The driving pulse ton1 of the electronic switch S1 and the driving pulse ton2 of the electronic switch S2 are regulated by PWM. The transient control characteristic, voltage adjustment rate and load adjustment rate of the main loop current of the resonant circuit are equivalent to the output characteristic of the current-type PWM control circuit in the state of the hard switching circuit.

### INDUSTRIAL APPLICABILITY

It avoids the problem that the resonant circuit conversion n efficiency is reduced and the main loop current is out of control under no loading or light load condition when the resonant circuit adopts PFM+PWM two control methods.

As for the preferred embodiment of the invention, it should be pointed out that for ordinary technicians in the field, a number of modifications and improvements can be made on the premise of not deviating from the concept of the invention creation, which are within the scope of protection of the invention.

### SEQUENCE LIST TEXT

Input the paragraph which describes the sequence list text here.

1. A resonant circuit converter includes: a resonant circuit, which is characterized by:
Lease enter claim 1 here.
Main loop energy detection circuit, including: the main loop current sensing rectification circuit, current comparator and current slop compensation circuit, the input of the described main loop current sensing rectification circuit samples the described main loop current Ip per cycle, The output of the described main loop current sensing rectification circuit is connected to the input of the described current slop compensation circuit and one input of the described current comparator. The other input of the described current comparator is connected to the reference voltage Vf.
Dual port PWM control circuit, including: Voltage comparator, OSC oscillator and PWM phase split control, one of the input of the described voltage comparator is connected to the output of the described current slop compensation circuit.
The other input of the described voltage comparator is connected to the output of the resonant circuit Vo. the reset terminal of the described OSC oscillator is connected to the output of the described current comparator. the output of the described voltage comparator and the output of the described OSC oscillator are connected to the inputs of the described PWM phase split control.
The described PWM phase split control output drive pulse ton1 and drives pulse ton2, the driving pulse ton1 is used to drive the electronic switch S1 in the resonant circuit, and the driving pulse ton2 is used to drive the electronic switch S2 in the resonant circuit.

2. According to the resonant circuit converter described in claim 1, its characteristic is that the lowest oscillation frequency fm of the OSC oscillator is less than the center frequency fo of the resonant circuit of the main loop.

3. According to the resonant circuit converter mentioned in claim 1, its characteristic is that the resonant circuit is one or more of series resonant circuit, parallel resonant circuit, series parallel resonant circuit and LLC resonant circuit.

4. According to the resonant circuit converter mentioned in claim 1, its characteristic is that the topology of the resonant circuit can be one or more of the full-bridge structure, half-bridge structure, push-pull structure.

5. Resonant circuit converter control method, its characteristic is that the use of any claim 1-4 of the described resonant circuit in the converter to control the output characteristics of the resonant circuit, by changing electronic switch S1 ton1 drive pulse width and electronic switch S2 ton2 drive pulse width, the described resonant circuit regulates the output voltage Vo of the described resonant circuit.

6. According to the resonant circuit converter control method described in claim 5, its characteristics are that the driving pulse ton1 and driving pulse ton2 output by the PWM phase split control, and the on pulse is controlled by the output pulse Ip23 of the current comparator.

7. According to the resonant circuit converter control method described in claim 6, its characteristics are that the input of the main loop current sensing rectification circuit samples the main loop current Ip of the resonant circuit, rectify and output voltage signal Ip21 to one input of the current comparator, and compared to the reference voltage Vf connected to the other input of the described current comparator.

8. According to the resonant circuit converter control method described in claim 6, its characteristic is that the dead time td of the OSC oscillator is less than the waveform TZVS time at the output end of the main loop current sensing and rectification circuit.

9. According to the resonant circuit converter control method mentioned in any item of claim 6-8, its characteristic is that the drive pulse ton1 and drive pulse ton2 output by the PWM phase split control are controlled by the comparison result of the output pulse Ip22 of the current slope compensation circuit and Vo.

10. The control method of the resonant circuit converter according to claim 9, its characteristic is that, when the output pulse Ip22 of the described current slop compensation circuit is greater than Vo, in the output of the described voltage comparator outputs pulse Vp31 to another input terminal of the PWM phase split control, PWM phase split control send the pulse Vp31 as the shut off pulse of the conduction half cycle of ton1 and ton2, the electronic switch of the described resonance circuit shut off the conduction half period; The resonant circuit completes PWM regulation of the output voltage Vo.
